(19) United States
(12) Patent Application Publication
(10) Pub. No.: US 2008/0195499 A1
(43) Pub. Date: Aug. 14, 2008

(54) Method Of Providing Cash And Cash Equivalent For Electronic Transctions

(75) Inventors: Thomas Meredith, Roswell, GA (US); Howard Meiseles, Alpharetta, GA (US)

Correspondence Address: ANDERSON, LEVINE & LINTEL L.L.P., 14785 PRESTON ROAD, SUITE 650, DALLAS, TX, 75254, US

(73) Assignee: Thomas Meredith, Roswell, GA (US)

(21) Appl. No.: 11/573,432

(22) PCT Filed: Aug. 18, 2005
(86) PCT No.: PCT/US05/29321

§ 371 Date: Feb. 8, 2007

Related U.S. Application Data
(60) Provisional application No. 60/602,952, filed on Aug. 19, 2004.

(51) Int. Cl. G06Q 20/00; G06Q 30/00; G06Q 40/00

(52) U.S. Cl. 705/26; 705/44; 705/37; 705/30

(57) ABSTRACT

A system for peer-to-peer commerce includes electronic wallets 14 for storing electronic token files 12. The electronic tokens can be passed from wallet to wallet without oversight of a third party. At any time, the owner of a token can verify the validity of a token for a fee, but such verification is not needed to conduct commerce. The electronic tokens include a field which can be used to restrict tokens to a specific purpose or to prevent use on specific goods and services.

### TECHNICAL FIELD

This invention relates in general to electronic financial transactions and, more particularly, to a method and apparatus for providing cash and cash equivalents for electronic transactions.

### BACKGROUND ART

Existing electronic payment methods have developed over the years by integrating several disparate proprietary systems, resulting in tremendous redundancy and resultant structural overhead. Current system complexity and overhead precludes the ability to inexpensively record and track transactions between individuals. These methods include, but are not limited to: Credit and Debit Card processing (including Point of Sale, or “POS”, terminals, Telephone and Internet based transactions), accessing ATM (Automatic Teller Machine) Networks, domestic check processing (Automated Clearing House or “ACH”) and interbank transfers (SWIFT—Society for Worldwide Interbank Financial Telecommunications, Wire Transfers) and others.

There is a worldwide industry of banks and merchants that have created an issuing network (Banks, Credit Card companies) and an acquiring network (specialized transaction processors representing merchants) that reconcile debit and credit card transactions internationally. The costs for even the largest merchant is in the 2% range and in the case of credit cards, the purchase is subject to considerable rates of fraud as well as repudiation of the transaction altogether.

It is very expensive to acquire a merchant account from the banks to process a credit card. Interfacing to payment processors also can require the assistance of a technically skilled programmer especially if conducting the transaction via web site. There is also the risk of fraud, which is especially rampant on the Internet as the credit card itself is not present without a verifiable signature and third party form of identification. There is also the risk of chargeback or refusal to pay by the buyer for up to 6 months or more even after the transaction was made. During this settlement period, the seller does not have access to a certain percentage of his transactions. This settlement length and percentage held back is different for each processor until a long enough time period has elapsed to establish a pattern for the processor to reduce the time required. There is always a settlement period and consequently, the seller never has immediate access to all the monies owed to him by the processor.

These complicated and expensive electronic payment systems are well suited for banks and large merchants who can afford the maintenance and security required to run a large website payment system. However, the advent and rapid growth of peer-to-peer networks have changed the way that individuals communicate with each other and eventually conduct business with each other.

In many cases, the dollar value of transferring the rights of the stored value from one individual to another individual or corporate entity is too small and the rights transfer process itself too cumbersome for current payment mechanisms to be economically feasible. Certified checks are perfect to purchase automobiles, but do not guarantee the transference of the title. Credit cards provide protection to the consumer using them, but do not provide an irrevocable transfer of value to the selling merchant as cash does. Adjudication processes are in place to ameliorate these situations, but only serve to increase the general system overhead and cannot be applied to low price, high volume transactions as in purchasing music via the Internet.

Peer to Peer Networks Description

This new form of Internet based communication, called Peer-to-Peer (P2P), has quickly grown to over 400 million individuals participating worldwide. A P2P communication is characterized as a communication directly between individuals without a central coordinating server. The main usage of these P2P networks has been to share music and video files between the individual users themselves. Well known programs that facilitate P2P communications include BitTorrent, Gnutella, and Kazaa (Fasttrack).

P2P networks significantly reduce costs associated with traditional client server methods of large file distribution by using the processing overhead and bandwidth available to any user of the Internet. Using a communications and security stack of protocols defined by the particular P2P network, a direct connection is made between individuals that wish to conduct business. This direct connection between the individuals requires no communications bandwidth or processing time of a centralized server and permits private transactions known only to the two parties to the transaction.

Unfortunately, many of the files being shared amongst these individuals are considered copyright infringement by the music and movie industries. There are tremendous litigation efforts underway as a means to staunch the infringement. Many within the industry believe that it is impossible to stop the alleged infringement by lawsuits due to the widespread worldwide and relatively anonymous usage of the P2P networks.

Consequently, the content creation industry, including music, movies and television, are adopting Digital Rights Management (DRM) systems that can codify, protect and manage the legal transfer of digital rights of electronic content (music, movies, etc.) between individuals who may or may not know each other.

Digital Rights Management Description

One of the first Digital Rights Management system to be developed and implemented into a Open Standard is XrML. XrML has been adopted by the international standards body as an approved ISO standard and represents a language for digital rights management, providing a universal method for specifying rights and conditions associated with the use and protection of digital content and services.

Originally developed at Xerox's Palo Alto Research Center (PARC), the specification facilitates the creation of an open architecture for rights management of digital content or services. It can be integrated with both existing and new DRM systems. XrML is a general-purpose rights language, agnostic to the type of resource, platform, media or business applications. The latest release, XrML 2.0, expands the capabilities of a Digital Rights Language to enable developers to establish the rights and conditions needed to access Web Services in addition to discrete digital content. It also contains additional capabilities in the areas of extensibility, security and life cycle management.

Other DRM Systems include: XACML (OASIS Standard) to enforce policy and access to services and content using Roles; Contentguard, recently adopted by the International Standards Organization (ISO) as a worldwide Standard; Open Digital Rights Language; and, the implementation Framework of OpenIPMP for protecting and managing Digital media assets.

The business processes are embedded in the DRM or “Wrap” of the content. For instance, in the case of distribution of music content, the Wrap can dictate how many times a song can be copied, in what format it can be played, and so on.

Electronic Cash Systems

Currently available or proposed digital coin systems can be classified as:
1. Physically stored value systems, where the money is stored electronically in a physical object, such as a smartcard that could contain Electronically Stored Value (ESV);
2. Centralized account based systems, where the digital token is a primary key to an accounting system kept at a bank or other similar financial institution; or
3. Electronic token based systems that are designed to eliminate double spending as discussed in D. Chaum, “Blind Signatures For Untraceable Payments,” Advances in Cryptology—Proceedings of CRYPTO 82 (1983) pp. 199-203, Plenum Press.

These prior systems were designed and engineered for levels of acceptable risk of fraud, and all users of the systems must accept this fraud and risk profile. Further, these systems have the following failings particular to their design:
1. Physically stored value systems require an extensive infrastructure to be able to read, debit and credit smart cards from remote locations. This lack of infrastructure has so significantly hampered the growth of the US smart card industry as to be virtually nonexistent.
2. Centralized account based systems, while conceptually simple, have two serious problems: (1) Inability to economically scale to handle worldwide transaction volumes. This includes the secure bandwidth, transaction processing and storage needs required for every transaction; (2) Loss of privacy when the coin value is reconciled with the specific individuals' accounting records upon every single use
3. Token-based systems as implemented in the past have still required a centralized system for redemption and did not have any bundled intelligence specific to that particular token to be able to conduct transactions without a centralized server. In other words, though the tokens themselves were decentralized, they could not be used in a decentralized peer to peer environment because of the risk of fraud and double spending.

With regard to traceability, commercial implementations of anonymous systems have not been met with open arms by either the banking or governing bodies. Clearly such a system would have too much potential for money laundering. This poses a significant challenge in providing decentralized P2P transactions.

Whatever the precise merits, features and advantages of the above cited references, none of them achieves or fulfills the purposes of providing a low cost method of conducting guaranteed decentralized P2P transactions across a wide spectrum of electronically stored value systems.

It is the principal object of the present invention to lower the cost of transactions between individuals below that which the current financial services industry allows. Another major object is to integrate this lower cost transaction processing method with industry accepted DRM platforms, thus providing a private, secure and guarantee-able method of transferring digital rights between individuals across a wide spectrum of electronically stored values.

### DISCLOSURE OF INVENTION

In a first embodiment of the present invention, commerce over a network is performed by, at a first processing device, receiving electronic token files having a specified value at a first processing device and sending an appropriate set of electronic token files over the network to a second processing device in return for a desired good or service. At a second processing device the set of electronic token files are received from the first processing device over the network and the authenticity of one or more of the set of electronic token files are optionally verified.

In a second embodiment, commerce over a network is performed by, at a first processing device, receiving electronic token files at a first processing device, where the electronic token files include a first field identifying a specific value for the token and a second field containing restrictions on the use of the monetary value of the token and sending an appropriate set of electronic token files over the network to a second processing device in return for a desired good or service which falls under the restrictions. The set of electronic token files are received at a second processing device from the first processing device over the network.

### BRIEF DESCRIPTION OF DRAWINGS

For a more complete understanding of the present invention, and the advantages thereof, reference is now made to the following descriptions taken in conjunction with the accompanying drawings, in which:

FIG. 1 illustrates a diagram of a basic commerce transaction using electronic token files;

FIG. 2 illustrates an embodiment for a electronic token file;

FIG. 3 illustrates an embodiment for a confirmation;

FIG. 4 illustrates a block diagram of a system for conducting commerce with the electronic token files;

FIG. 5 illustrates a basic transaction without escrow or verification;

FIG. 6 illustrates a transaction with escrow and file locking to protect buyer and seller;

FIG. 7 illustrates a block diagram of locked digital file which requires a payment and a key to release its content and automatically forwards the payment to seller;

FIG. 8 illustrates a block diagram of a locked digital file which pays diverse ownership rights upon release of its contents;

FIG. 9 illustrates a block diagram of the interface for an electronic wallet; and

FIG. 10 illustrates a block diagram showing the peer relationship between stored value servers and between electronic wallets.

### BEST MODE FOR CARRYING OUT THE INVENTION

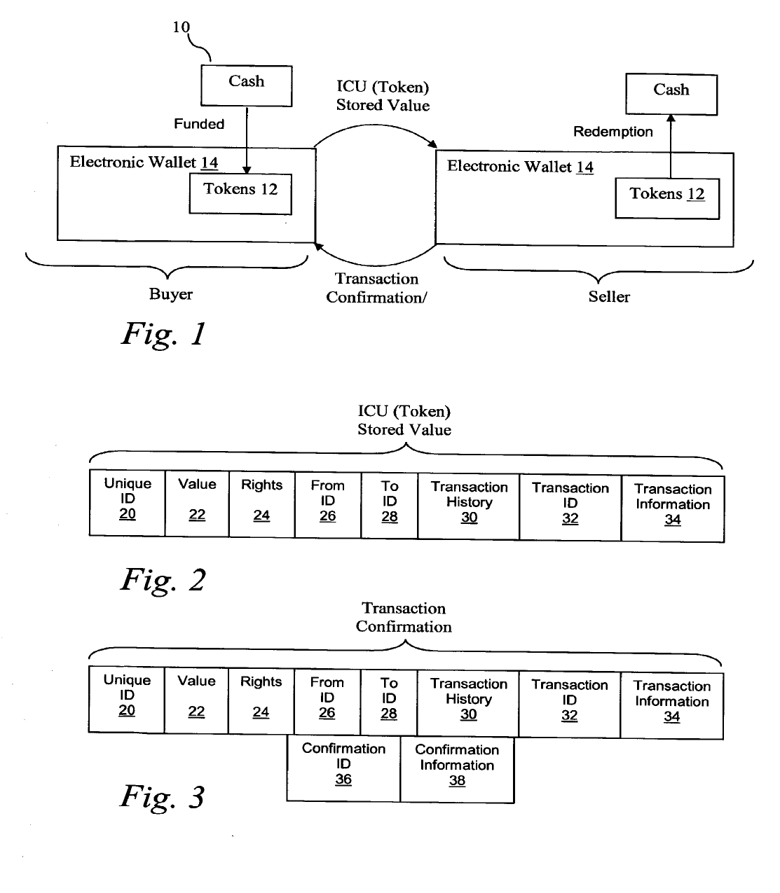

The present invention is best understood in relation to FIGS. 1-10 of the drawings, like numerals being used for like elements of the various drawings.

FIG. 1 illustrates a diagram of the overall operation of the invention. The invention enables the use of electronic cash or cash equivalents, such as manufacturer coupons, frequent flyer miles and store credits, in furtherance of electronic commerce. Further, the invention provides for the auditing the transaction and the delivery of the purchased item.

In the embodiment of the system shown in FIG. 1, cash or cash equivalents 10 are converted into an electronic currency (shown as tokens 12), which are stored in an electronic wallet 14, which is a program being executed on a processing device, such as a computer, mobile computer (including digital assistants or “PDAs”), smart card or mobile phones. The tokens could be stored in a memory that could be transported between computing devices, such as a FLASH memory, smart card or other non-volatile memory. In the process of an electronic transaction, tokens are sent from the buyer's electronic wallet 14 via some network technology to the seller's electronic wallet 14. The network technology could be the Internet, or include the Internet as part of the network—but it could also include other public or proprietary networks that are either coupled to the Internet or completely separate from the Internet. Additionally, in the preferred embodiment, it would be possible to send the tokens in a variety of manners, such as by attachment to email, instant messaging or text message for mobile phones (such as an SMS—“Short Message Service” or MMS—“Multimedia Messaging Service” message). The seller's electronic wallet 14 confirms the transaction to the buyer's electronic wallet 14. The seller is then able to redeem the tokens into cash or cash equivalents, or to retain the tokens for future purchases.

FIG. 2 provides an overview of a token 12. A token is a XML (extensible markup language), or similar, electronic file, preferably encrypted using publicly available encryption technologies such as SSL (secure sockets layer), AES (advanced encryption standard), or DES (date encryption standard). Since cryptology is an evolving science the form of encryption will change over time, and any suitable encryption technique can be used with the tokens 12.

A token 12 includes several fields for storing information. The UniqueID field 20 uniquely identifies a token file. Examples of embodiments of the UniqueID Field 20 include a time and date stamp set at the beginning the transaction appended with MAC (Media Access Control) address of the issuing device.

The Value field 22 is the monetary representation of the value of token. The value field could indicate both the number of units and the type of units, for example “100 dollars” or “100000 frequent flyer miles”.

The Rights field 24 is a field that can be used to restrict the use of the monetary value of the token. In some cases, the rights may be restricted by the issuer of the token 12. In the preferred embodiment, the restriction of rights is flexible to accommodate a variety of circumstances. For example, tokens may be issued to the buyer responsive to a coupon possessed by the buyer; the Rights field 22 of these tokens may restrict the used of the tokens to a product or set of products, or services, provided by a specific company and/or a reseller in a specific time period. In a second example, tokens may be purchased as a gift with certain restrictions, such as the tokens could only be used to purchase an age appropriate product or service. The rights field 24 may indicate that the token may be used for any use, without restriction, or the Rights field 22 may specify any combination of rights for the token.

The FromID field 26 provides a specific identifier for the actual user initializing the transaction. The ToID field 28 provides a specific identifier for the actual user receiving the transaction.

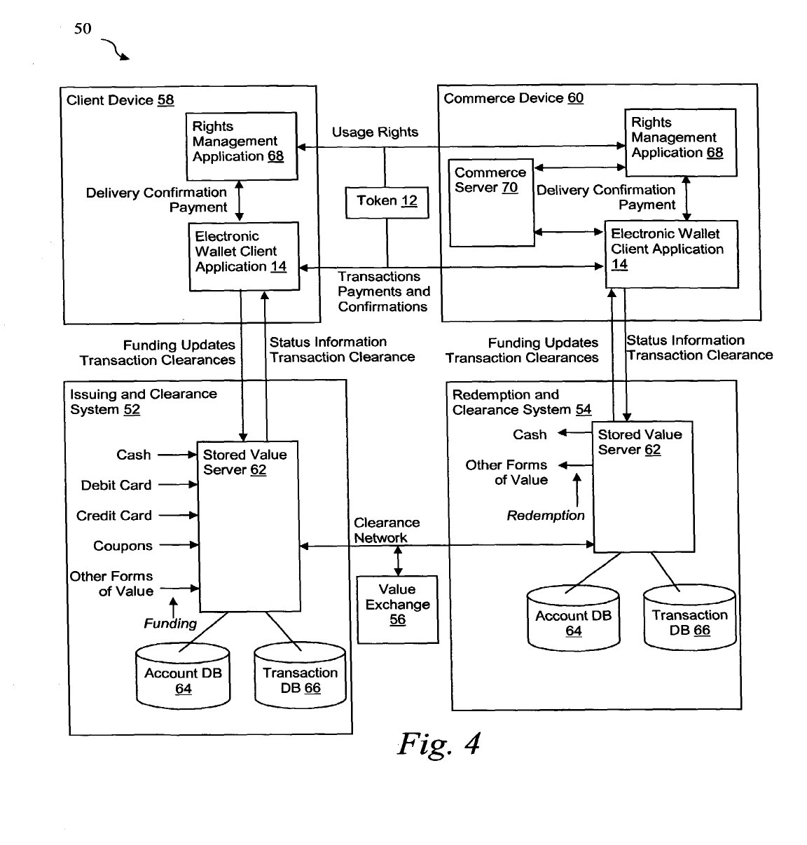

The History field 30 provides an archival log of the transactions that the particular token has been involved in since it was last cleared by a clearance system (see FIG. 4, below). This field provides the ability to trace the token over a series of transactions by logging each transaction, thereby providing an audit trail. The history log includes all the token fields. Upon clearance, the information from the History field 30 is stored external to the token in a database.

The TransactionID field 32 is an identifier of the transaction provided by the seller.

The TransactionInformation field 34 is a text string that describes the items being purchased with the tokens (or a set of tokens).

As shown in FIG. 3, in the transaction confirmation, two fields are added to the token. A ConfirmationID field 36 provides an identifier from the seller that the transaction has been accepted and the purchased items are ready for shipment. A ConfirmationInfo field 38 includes a text string providing the delivery information for the items purchased.

FIG. 4 illustrates a functional block diagram of a system 50 for overseeing commercial transactions using the tokens 12. The system 50 is comprised of six major sections: the issuing and clearance system 52, a redemption and clearance system 54, a value exchange 56, the client device 58 (such as the buyer in FIG. 1), the commerce device 60 (such as the seller device in FIG. 1) and the token 12.

The issuing and clearance system 50 is the portion of the system that establishes and maintains the accounts for various users, provides communication with the electronic wallet client applications of the users, provides a transaction system to exchange money or other forms of value into electronic token form, provides communication with other clearance systems and stores the history of the transactions per account. Account information is maintained on a stored value server 62, in conjunction with an account database 64 and a transaction database 66. Funding mechanisms that can be used to purchase tokens include cash, debit cards, credit cards, coupons and other forms of value.

The function of the establishment and maintenance of the accounts on the issuing and clearance system enable the system operator or the account user to establish an account, delete an account, transfer value into and out of the account, audit the account, and provide reports on transactions of the account. Additionally, the issuing and clearance system provides an IP logical linkage between the account and the electronic wallets associated with the account. There can be more than one electronic wallet on an account since a user might have many network-connected devices to provide transaction such as cellphones, PDA's, and computers. Accordingly, the issuing and clearance system 52 can also move value between electronic wallets 14 associated with a single account. Similarly, a user may have multiple accounts (such as a business and personal account or separate accounts for different family members) on a single device.

When a user logs onto his or her account on the stored value server 62, the stored value server 62 and the appropriate electronic wallet 14 (the particular electronic wallet associated with the account and the device logging onto the system issuing and clearance system 52) communicate over a secure protocol such as SSL. The first synchronization function that occurs between the client and the server is that all the stored tokens and transactions in the wallet are cleared. Once the transactions are cleared all the associated tokens with those transactions are removed from the wallet and the value represented by the tokens is credited to the appropriate account.

The histories of all the transactions associated with the account are logged into the electronic wallet 14. If the user has multiple wallets 14 associated with the account, the transaction history of all the electronic wallets 14 are maintained in any associated wallet, thereby giving the user the ability to view their transactions without connecting to the server.

After the synchronization is completed the user can fund or redeem value into their account from the connected electronic wallet.

The system user or the account user, depending on whether the account to be debited is physical (i.e., cash) or virtual (i.e., an electronic transfer from an account, such as a credit card), can accomplish the process of adding value to an account using the stored value server 62. If the value is physical, funds are received directly and the value and the rights associated with the value are credited to the account. If the value is virtual, a set of screens takes the user through the process of debiting the virtual system and then crediting the account on the server 62. As part of this process the rights for the funds is determined and implemented.

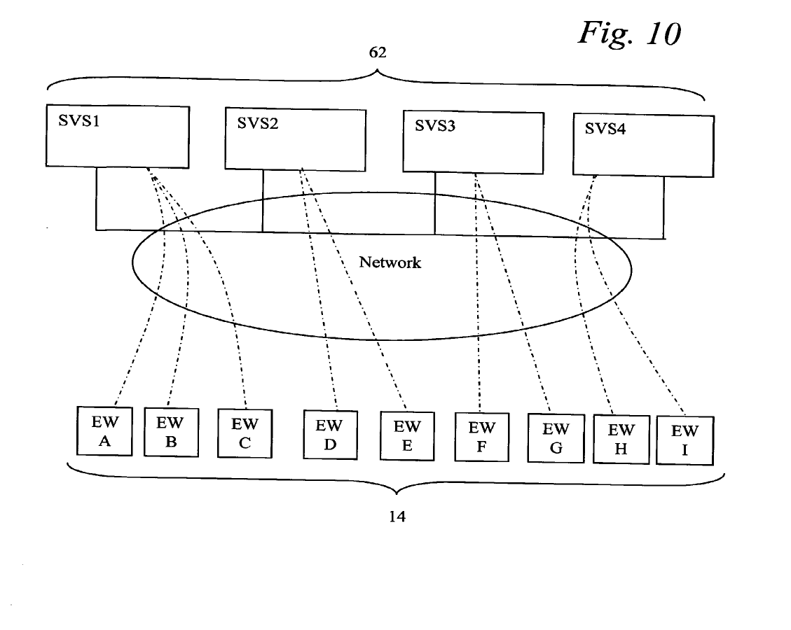

The last major function of the issuing and clearance system 52 is the clearance of transactions. As tokens 12 are used for transactions and synchronized with the stored value server 62, the servers 62 associated with the buying and selling parties, by reference to the FromID and ToID fields of a particular token 12, identify the accounts for a transaction. The servers 62 communicate over a secure network and instantly clear the transactions. As described in connection with FIG. 10, the servers 62 for various parties are also connected in a peer relationship, such that the overall maintenance and control of the transactions using tokens is distributed, rather than centralized. This provides several benefits: (1) the cost of maintenance and control is reduced by eliminating the need for a central server capable of overseeing billions of transactions; (2) temporary failure of any one server 62 will only affect a small portion of the system, (3) security is increased, since clearing of tokens requires clearing back through each server involved in each transaction listed in the transaction history field 30 of the token 12, all the way back to the issuing server 62.

As part of the clearance of the transaction, a background check may take place to ensure that confirmations for delivery are also processed. So in a short session the entire system knows that a transaction between two users has taken place that the items have been shipped and received and the funds are transferred. If any of these elements are not complete, the transaction and associated funds are placed in a form of escrow until the elements complete.

Another function of the issuing and clearance system 52 is the ability to prepare reports for the user or the system operator of the transaction activity.

The operation of the redemption and clearance system 54 is very similar to the issuing and clearance system 52. As in the issuing and clearance system 52, the redemption and clearance system 54 includes a stored value server 62 coupled to and Account database 64 and a transaction database 66. The redemption and clearance system 54 is also able to redeem tokens in the users account into hard value such as cash or other types of value such as frequent flyer miles. In essence the user account is debited for the value of a token and the external system (the user's bank or other account) is credited with the value. This process is the inverse of the issuing portion of the system that exchanges hard value for tokens.

The value exchange system 56 exchanges different forms of value. For example, if a transaction is performed in a first currency and the stored value is designated in a second currency, the values of the currencies are exchanged by the value exchange system 56. The operation of the value exchange system extends beyond currency-to-currency transactions, since some other forms of value can be exchanged, such as frequent flyer miles to cash, coupons to cash, cash to frequent flyer miles and so on. For example, users of the system might desire to exchange frequent flyer miles for currency. In addition, restrictions in the rights field 24 will affect the value of a token.

The value exchange system 56 allows traders to place an equivalent exchange rate on the differing forms of value represented by the tokens. For example, tokens could be valued in dollars, dollars restricted to certain products, rubles, frequent flyer miles, and so on. The value exchange system could use a bid-ask process to provide a market for different types of tokens. Alternatively, an auction process could be used. Accordingly, tokens in different established monetary terms could be exchanged, such as dollars to tokens, as well as tokens value non-monetary values, such as frequent flyer miles for dollars, or frequent flyer miles for store credits.

The client device 58 can be performed on any network connectable electronic processing device. The client device 58 executes the electronic wallet client application 14 that communicates with the issuing and clearance and redemption and clearance portions of the system. The electronic wallet client application 14 also communicates with any DRM functionality on the client device so that a guarantee of delivery can be determined. Finally, the wallet 14 creates tokens 12, as needed, to perform transactions, based on the value stored in the wallet.

From functionality standpoint, the software on the client device permits the exchange of tokens with other devices that have electronic wallets 14, such that transactions can be executed using tokens as a form of value.

The Commerce device 60 is a special implementation of the client device 58. In addition to the electronic wallet 14 and the rights management application 68, the commerce device 60 includes a commerce server 70 which provides an interface for conducting commerce and software to secure the goods for shipment.

The external user (i.e., buyer) communicates with the commerce device 60 via some kind of network, such as the Internet. If the buyer would like to purchase goods or services over the commerce server 70, the user's electronic wallet 14 on the client device 58 communicates with the electronic wallet 14 on the commerce device 60 to establish a transaction that is consummated with the transfer of tokens 12. In a second part of the transaction, the purchased goods or services are secured and the security and shipping (or performance, in the case of services) information is transferred as part of the token information exchange in the confirmation field 38. When the user receives the secured and shipped goods (or performed services) and disabling the security, an additional exchange takes place to confirm the delivery of the good. This shipping can either be virtual or physical.

In the end, the transaction is cleared with one of the clearance systems on the communication network and the hard value is instantly exchanged between accounts.

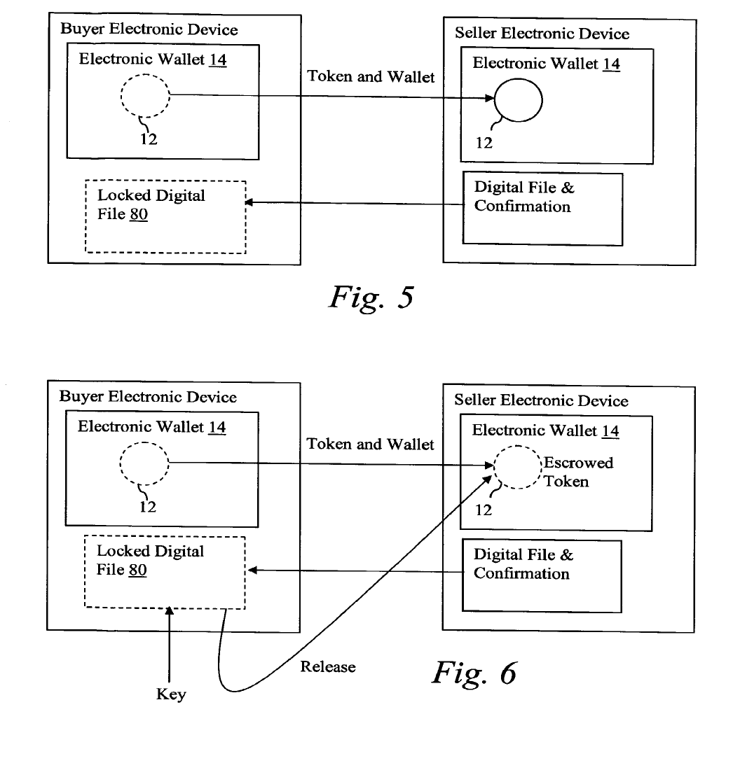

FIG. 5 illustrates a diagram showing a basic transaction using tokens. A first party (“Buyer”) agrees to purchase a digital file from a second party (“Seller”). The agreement to purchase could be made through a variety of mechanisms, such as an oral agreement, an on-line auction, or an on-line storefront. It is assumed in this basic example, that the file is not subject to copyright restrictions on transfer and does not involve DRM considerations. Once the purchase is confirmed, Buyer sends one or more tokens to cover the purchase price to Seller. If Buyer does not have enough tokens in his wallet 14 to cover the purchase, then the wallet 14 issues additional tokens to cover the cost of the purchase. Any newly issued tokens will be traceable to the issuing wallet. In the preferred embodiment, Buyer can send an electronic wallet application 14 along with the token—if the Seller already has an electronic wallet 14, the application can be ignored; otherwise, the Seller can execute the wallet application 14 and use it immediately to store the tokens 12 from Buyer.

Upon receiving the token, Seller sends the file to Buyer along with the confirmation shown in FIG. 3. The transaction is now complete.

The basic transaction shown in FIG. 5 is similar to many transactions now commonly conducted in commerce—the buyer trusts the seller to ship the purchase goods, either physically or electronically, upon receiving payment. The seller trusts that the buyer is paying legitimately—i.e., that the token is genuine. However, the tokens 12 used in the transaction do not have the downsides of current payment systems. Unlike cash, the tokens can be traced to confirm delivery to the seller. Unlike checks or credit cards, the buyer does not reveal important financial information, such as account numbers, that could be used fraudulently by a crooked seller.

The basic example provided above, involves some degree of trust between buyer and seller, particularly on the part of the buyer, who sends tokens prior to receiving or inspecting the goods. A second example is shown in FIG. 6 in which confirmation of a complete transaction can be performed prior to either party having possession of their end of the bargain.

In FIG. 6, Buyer has again purchased a digital file from Seller. In this case, however, the Buyer has specified a secured payment, where the money is placed in escrow (in the illustrated embodiment, the escrow is maintained in Seller's wallet 14, although the escrow could be designed for the Buyer's wallet 14 or a third party site as well), so that the Seller cannot immediately use the token. In response to receiving the escrowed payment, a “locked” (i.e., not currently usable) digital file 80 is obtained by Buyer. The file could be locked in a fashioned described in connection with U.S. Pat. No. 6,389,541, which is incorporated by reference, or a similar scheme. It is assumed that Seller sends the file 80; however, it would be possible that Buyer has obtained the file 80 elsewhere and the purchase is for the rights to use the file 80, for which a “key” is required. At this point, Buyer has a file 80 that he cannot use and Seller has a token 12 that he cannot use. It is assumed that portions of the locked digital file are unencrypted such that the Buyer can confirm the integrity of the file 80, the rights conferred by an embedded DRM (such as unlimited uses on up to three computers, or rights to burn to a compact disk, or a date certain at which use will terminate). Once Buyer is assured that he has received the correct file 80, he performs an action, such as double-clicking on the file 80 to enter a key supplied by Seller. Entering the key performs two functions: (1) the digital file 80 is unlocked for use by Buyer in accordance with a DRM, if any, and (2) a release message is sent to Seller to release the escrowed tokens 12.

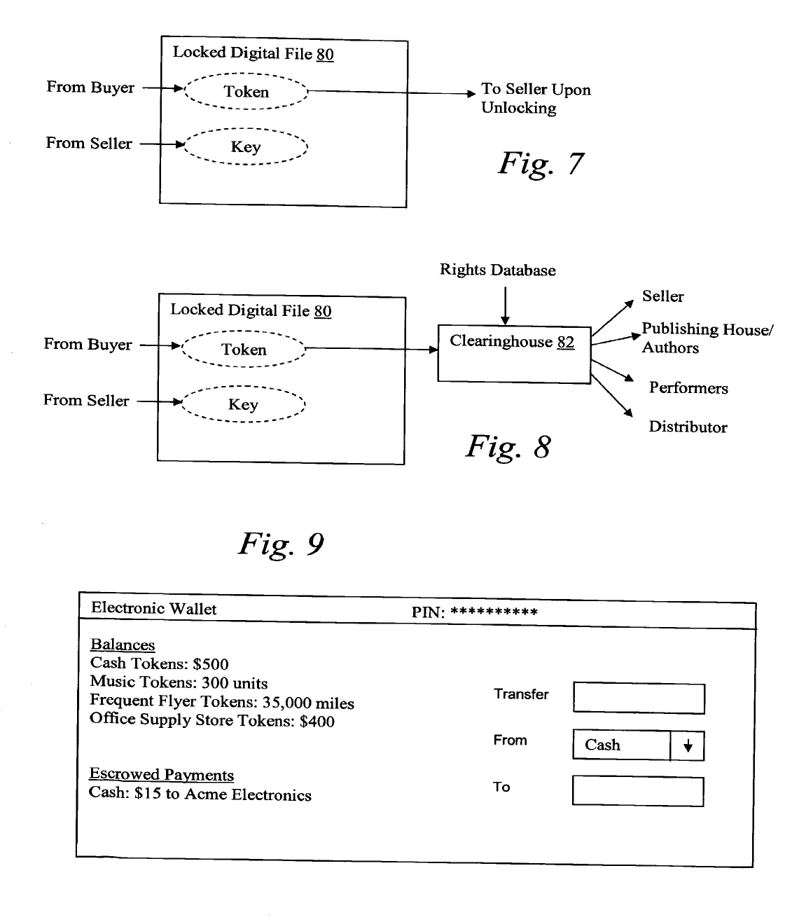

The escrowed payment function could be implemented in a number of ways. In an alternative embodiment shown in FIG. 7, the Buyer obtains a locked digital file 80. To unlock the file, two things are necessary: (1) a token in sufficient amount to pay for the file and (2) a key. As before, the file 80 (or associated file) provides enough information for the Buyer to reasonably confirm its authenticity and its cost. The Buyer confirms his purchase by, for example, dragging one or more tokens to the file 80, which causes a message to be sent to Seller (the rights owner, or agent therefore), requesting a key. At this point, the token is committed to the particular file and cannot be used for another transaction without undoing the current transaction prior to unlocking. When the seller returns with the key, the contents of the file are released and the tokens are sent to Seller.

FIG. 8, using the embodiment of FIG. 7, another variation is shown, where the system automatically compensates multiple rights owners in a file upon payment. In this case, opening the file sends the token to a clearinghouse 82, where the various rights in the file 80 are determined, in this case by reference to a database. For example, for a music file, there can be a number of parties who are entitled to payment upon sale of a file. The Seller, authors of the song (whose rights may be owned by a publishing house, or whose rights may have been transferred to another), performers and distributor (i.e., record company) may all take a cut in the amount paid by Buyer. In the embodiment shown in FIG. 8, a clearinghouse 82 receives the payment from Buyer, rather than the Seller, and determines the amount to be paid to each entity. These amounts could vary depending upon a number of factors—for example, each seller may have different deals with the various entities, so the breakdown of payments may vary upon the particular Seller from which the Buyer purchased the song and the price paid by the Buyer. Additionally, the various rights may change over time, and may change frequently, so it is beneficial that the rights breakdown be stored in a common database.

This aspect of the invention provides significant advantages in commerce for certain situations. Because the present invention has low overhead in comparison to present day system, it is very amenable to small transactions. Thus, it would be possible to sell music or software applications for a small per use fee, for example, two cents per play of a music file. A consumer could purchase 20 or 30 plays of a file, or the payment could be made each time the file was played. For every purchase of rights (or for each play), the remunerations to all the parties would be made.

Also, the present invention can make legitimate use of the peer-to-peer file sharing technologies that are commonly used for illegal transfer of copyrighted files. Currently, there are significant costs in starting a legitimate music/video service, since the service owner must provide bandwidth for downloading music files at peak times. Using the present invention, consumers could obtain a DRM protected file using peer-to-peer file sharing technologies, such as Kazaa or BitTorrent. Since the file is protected by the DRM, it could not be used before the proper licensing (key) was obtained through payment of the appropriate fees. To encourage other user's to share their bandwidth, a portion of the seller's fees could be sent to the users involved in the file sharing, depending upon the number of bytes transferred by the user. This would greatly reduce the amount of bandwidth provided by the main Seller, since the largely untapped bandwidth of the users could be used once copies of the DRM protected file were released to the public.

FIG. 9 illustrates a basic illustration of an electronic wallet. To access the wallet, a PIN (personal identification number) or other indicia of ownership, such as a fingerprint, voice sample, or eye scan, must be provided. From the electronic wallet, the owner can transfer money, verify tokens 12, check balances and so on. It is expected that an actual implementation would provide a graphical interface to facilitate operations.

It should be noted that while the preceding examples of payment of escrowed goods have been described in connection with the transfer of digital files, the same mechanism could be used with physical goods. For example, the tokens associated with a package sent to the Buyer could be released upon notification from a carrier that the package had been delivered. Additionally, payment of services could be released upon notification of performance.

A major advantage of basing the token on a peer-to-peer architecture is the leverage using the bandwidth and computer processing of individual users to complete transactions. The tracking and auditing of the transactions are accomplished by reporting the transactions to the stored value servers 62 in a distributed Web Services architecture. This significantly reduces the bandwidth and processing capabilities that would be typically required if all these transactions were to be tracked through a traditional client server architecture.

As tokens 12 are spent between parties, the tokens are tracked by the destination IP address (or other suitable addressing scheme). The tokens 12 are also tracked by the programs used to transfer the tokens from one person to another, such as the electronic wallets 14 and commerce servers 70. Since the parties to a transaction are connected to the network at the time of transferring the tokens, the transaction can be detected and recorded by the stored value servers 62 for later confirmation of the validity of the tokens. The system provides tracking ability of every token used in a transaction. To obtain this information, the transaction databases 66 can be accessed when presented with suitable legal authority to do so. This permits relative anonymity for transactions, with the ability to trace transactions when necessary for legal purposes.

As the tokens 12 are tracked, this information is sent via Web Services to a central database as well as embedded in the token itself as a form of data validation.

FIG. 10 shows a diagram of the peer relationships between stored value servers 62 (labeled as SVS1 through SVS4) and the peer relationships between electronic wallets 14 (labeled as EWA through EWI). Regardless of which stored value server 62 is associated with an electronic wallet 14, each electronic wallet 14 can transfer tokens to any other compatible electronic wallets 14. Thus, any device which can receive an attached file is capable of receiving tokens 12 from another device. The stored value servers 62 are also in a peer relationship. The stored value servers can communicate to one another without control by an overseeing central server. Thus, SVS2 is confirming a transaction between EWD and EWI, it can communicate directly with SVS4. Thus, a series of transactions can be easily and securely confirmed and cleared.

The embodiment described herein differs from prior art attempts at electronic coins in that verification of the validity of a token at any point in time is optional (i.e., the wallets can hold tokens 12 without verification or redemption), yet the history is stored with the token so that an accurate verification can be performed at any time. Thus, the invention provides the ability to conduct commerce over a peer-to-peer network without a centralized authority monitoring the transaction. Verifying a token 12 provides the owner assurance that the token is legitimate—but, the performance of the verification will generally incur a fee. Thus, a party can set his acceptance properties such that the Wallet verifies each received token 12 with the stored value server 62, but will incur a fee for doing so. On the other hand, the acceptance algorithm properties could rely on a previous history (such as feedback scores on on-line auction sites) which provides a general indication of the reputation of the party or parties that have previously held the token, to determine whether to have a token verified. The discretion in requesting verification can be based upon any desired combination of factors, such as the reputation of the buyer and other attributes of the token, as decided by the accepting party.

Automating the verification process reduces the costs of conducting transactions using token by verifying only those tokens that come from sources unknown or of potential distrust by the accepting party. Since most tokens will be relatively small in value, many individual parties may accept tokens without incurring the expense of requiring verification. Commercial accounts will likely redeem all tokens associated with a transaction, and will thus verify each token when received.

Not only can the electronic wallet 14, or other application, be customized to accept tokens of certain attributes, the wallet can be used in conjunction with a locked file to release content from a locked file based upon the proper amount of tokens 12 being offered. This makes true peer-to-peer commerce credible for the first time.

In addition to verification abilities, the present invention provides guaranteed transaction security and traceability by using the following emerging standard Web Services:
1. Identity verification of the individuals performing the transaction using newly issued industry standards (such as Security Assertion Markup Language or “SAML”, and the Liberty Alliance Project),
2. DRM standards to guarantee the validity of the content being purchased and
3. Banking standards (Interactive Financial Exchange—IFX, SWIFT, etc.) to guarantee the issuance and redemption of the tokens for value in any currency.

In describing the invention, various protocols and conventions have been specified in order to provide an understanding of the ability of the system. However, many of these protocols and conventions are evolving rapidly, for example DRM specifications, and the invention is adaptable to work with any existing or future specification.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A method of performing commerce over a network comprising:
at a first processing device:
receiving electronic token files having a specified value at a first processing device;
sending an appropriate set of electronic token files over the network to a second processing device in return for a desired good or service;
at a second processing device:
receiving the set of electronic token files from the first processing device over the network; and
optionally verifying the authenticity of one or more of the set of electronic token files.

2. The method of claim 1 wherein each of the token files include a history of the transactions in which they have been used.

3. The method of claim 1 wherein each of the token files has a unique identifier.

4. The method of claim 3 wherein the unique identifier comprises a code incorporating a unique identifier associated with an issuing device.

5. The method of claim 4 wherein the unique identifier associated with an issuing device comprises a MAC address associated with the issuing device.

6. The method of claim 1 wherein the value is specified as a monetary value.

7. The method of claim 1 wherein the value is specified as a non-monetary value.

8. The method of claim 1 wherein token files may have different value types and further comprising the step of exchanging tokens of different value types.

9. The method of claim 8 wherein said exchanging step comprises the step of exchanging tokens of different value types using a bid-ask process.

10. The method of claim 8 wherein said exchanging step comprises the step of exchanging tokens of different value types using an auction process.

11. The method of claim 1 wherein each token has a field for an identifier of a current owner.

12. The method of claim 11 wherein each token has a field for an identifier of a future owner.

13. The method of claim 1 and further comprising the step of tracking transactions involving a particular token without using a central clearing authority.

14. The method of claim 1 wherein said step of sending an appropriate set of electronic token files comprises the step of sending an appropriate set of electronic token files as part of a message to a mobile device.

15. The method of claim 1 wherein said step of sending an appropriate set of electronic token files comprises the step of sending an appropriate set of electronic token files over a data network.

16. The method of claim 1 and further comprising the step of restricting use of the electronic token files.

17. The method of claim 1 wherein the step of restricting use of the electronic token files comprises the step of prohibiting use of the electronic token files for certain age-inappropriate purchases.

18. The method of claim 1 wherein the step of restricting use of the electronic token files comprises the step of constraining use of the electronic token files for specified purchases.

19. The method of claim 1 wherein the step of optionally verifying the authenticity of one or more of the set of electronic token files comprises the step of automatically verifying the authenticity of electronic token files based on information contained in the electronic token files regarding previous transactions.

20. A method of performing commerce over a network comprising:
at a first processing device:
receiving electronic token files at a first processing device, where the electronic token files include a first field identifying a specific value for the token and a second field containing restrictions on the use of the monetary value of the token;
sending an appropriate set of electronic token files over the network to a second processing device in return for a desired good or service which falls under the restrictions;
at a second processing device:
receiving the set of electronic token files from the first processing device over the network.
